(19) United States
(12) Patent Application Publication
(10) Pub. No.: US 2026/0183750 A1
(43) Pub. Date: Jul. 2, 2026

(54) CATALYST METAL PARTICLE AND CATALYST

(71) Applicants: Shinichi HIRABAYASHI, Numazu-shi (JP); Taizo YOSHINAGA, Numazu-shi (JP); Hiroki SHIRAKAWA, Seto-shi (JP); Satoshi MAEDA, Sapporo-shi (JP); Tomoya ICHINO, Sapporo-shi (JP)

(72) Inventors: Shinichi HIRABAYASHI, Numazu-shi (JP); Taizo YOSHINAGA, Numazu-shi (JP); Hiroki SHIRAKAWA, Seto-shi (JP); Satoshi MAEDA, Sapporo-shi (JP); Tomoya ICHINO, Sapporo-shi (JP)

(73) Assignees: TOYOTA JIDOSHA KABUSHIKI KAISHA, Toyota-shi (JP); NATIONAL UNIVERSITY CORPORATION HOKKAIDO UNIVERSITY, Sapporo-shi (JP)

(21) Appl. No.: 19/428,459

(22) Filed: Dec. 22, 2025

(30) Foreign Application Priority Data
Dec. 27, 2024 (JP) 2024-232059

(51) Int. Cl. B01J 23/46; F01N 3/28

(52) U.S. Cl. CPC B01J 23/468; F01N 3/2807

(57) ABSTRACT

Provided is a catalyst metal particle containing Rh as a main component that can improve catalytic activity and a catalyst containing the catalyst metal particle. The catalyst metal particle according to the present disclosures includes a composition in terms of atomic ratio represented by the formula RhₓIr_{y}Pt_{z}, wherein x+y+z=100, 40≤x≤80, 10≤y≤40, and 10≤z≤40.

### CROSS REFERENCE TO RELATED APPLICATIONS

The present application claims priority from Japanese patent application JP 2024-232059 filed on Dec. 27, 2024, the entire content of which is hereby incorporated by reference into this application.

### BACKGROUND

### Description of Related Art

The present disclosure relates to a catalyst metal particle and a catalyst, particularly to a catalyst metal particle containing Rh as a main component and a catalyst containing the same.

### Background Art

Conventionally, catalyst metal particles containing platinum group metals, such as Pt, Pd, and Rh, have been used in exhaust gas purification catalysts that remove harmful components, such as NOx, in exhaust gases and catalysts for electrode catalysts in fuel cells, and various kinds of techniques related to such catalyst metal particles and catalysts have been developed.

As such catalyst metal particles and catalysts, for example, there has been known a catalyst with a catalyst composition effective for carrying out three-way conversion including platinum group metal nanoparticles (for example, nanoparticles of Pt, Pd, Au, Ru, Rh, alloys thereof, and mixtures thereof), the nanoparticles having an average particle size of about 15 nm to 50 nm, wherein the nanoparticles are dispersed on a refractory metal oxide component (JP 2020-508845 A). In addition, there have been known a multicomponent solid solution fine particle represented by PdₓRu_{y}M_{z} (M is at least one member selected from the group consisting of Rh, Pt, Cu, Ag, Au and Ir. x+y+z=1, x+y=0.01 to 0.99, z=0.99 to 0.01, x:y=0.1:0.9 to 0.9:0.1) and a supported catalyst containing the multicomponent solid solution fine particle (WO 2017/150596 A1). Furthermore, there have been known a ternary alloy nanoparticle containing a platinum group metal that is alloyed with at least two transition metal elements and a catalyst containing the ternary alloy nanoparticle (WO 2023/237734 A1).

### SUMMARY

Catalyst metal particles containing Rh, especially among the platinum group metals, as the main component, realize excellent catalytic activity, for example, in reducing NOx by exhaust gas purification catalysts, and such characteristics are utilized. In recent years, the price of Rh, especially among the platinum group metals, has been soaring. Therefore, reducing the amount of its use has become an urgent issue. On the other hand, even if the amount of Rh used is reduced, it is required to realize more excellent catalytic activity than ever before.

The present disclosure is made in view of these points, and provides a catalyst metal particle containing Rh as a main component that can improve catalytic activity and a catalyst containing the catalyst metal particle.

To solve the above-described problems, a catalyst metal particle of the present disclosure is a catalyst metal particle comprising a composition in terms of atomic ratio (a composition in atomic ratio) represented by the formula Rh Ir_{y}Pt_{z}, wherein x+y+z=100, 40≤x≤80, 10≤y≤40, and 10≤z≤40.

Furthermore, a catalyst of the present disclosure is a catalyst comprising: the above-described catalyst metal particle; and a carrier on which the catalyst metal particle is supported.

Effect The present disclosure can improve the catalytic activity.

### BRIEF DESCRIPTION OF THE DRAWINGS

FIG. 1 is a schematic perspective view of an exhaust gas purification device employing a catalyst according to one embodiment;

FIG. 2 is a schematic cross-sectional view illustrating a cross-sectional surface perpendicular to an extending direction of cells of the exhaust gas purification device illustrated in FIG. 1, which also illustrates an enlarged view of a cross-sectional surface of a catalyst layer;

FIGS. 3A to 3C are STEM images of catalyst pellets in Examples 5, 8, and 12, respectively;

FIGS. 4A to 4E are a STEM image of the catalyst pellets, an elemental mapping image of Rh, Ir, and Pt, an elemental mapping image of Rh, an elemental mapping image of Ir, and an elemental mapping image of Pt in Example 8, respectively;

FIGS. 5A to 5C are drawings illustrating a fixed-bed type flow reactor used for a catalytic activity evaluation, a temperature program used for the catalytic activity evaluation, and a mixed gas used for the catalytic activity evaluation, respectively; and

FIG. 6 is a graph illustrating the NO 50% conversion temperature of each sample of Examples 1 to 12 and Comparative Examples 1 to 6.

### DETAILED DESCRIPTION OF THE EMBODIMENTS

The following describes embodiments according to a catalyst metal particle and a catalyst of the present disclosure.

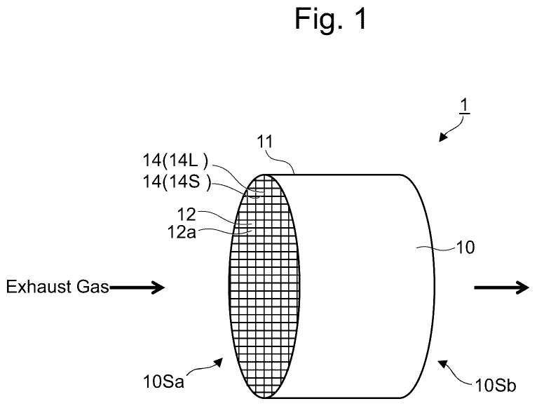

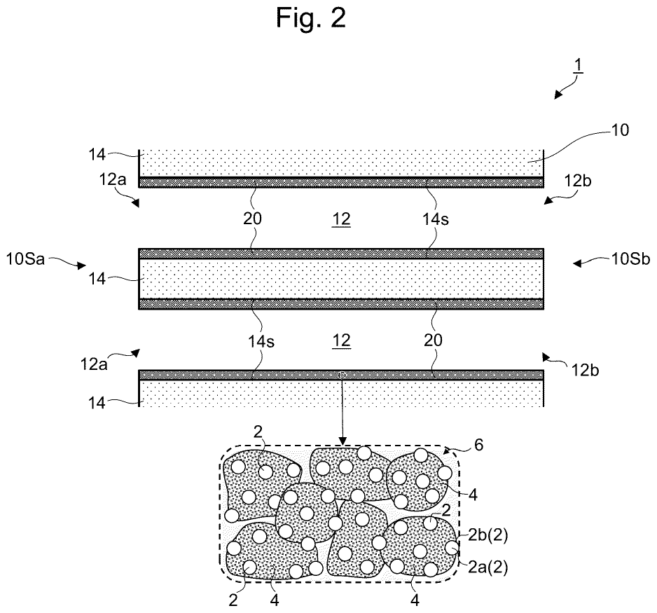

First, the outline of the catalyst metal particle and the catalyst according to the embodiments is described by exemplifying a catalyst metal particle and a catalyst according to one embodiment. FIG. 1 is a schematic perspective view of an exhaust gas purification device employing a catalyst according to the one embodiment. FIG. 2 is a schematic cross-sectional view illustrating a cross-sectional surface perpendicular to an extending direction of cells of the exhaust gas purification device illustrated in FIG. 1, which also illustrates an enlarged view of a cross-sectional surface of a catalyst layer.

As illustrated in FIG. 1 and FIG. 2, an exhaust gas purification device 1 employing a catalyst (exhaust gas purification catalyst) 6 according to the one embodiment is a device that purifies an exhaust gas discharged from an internal combustion engine in an automobile and the like. The exhaust gas purification device 1 is a three-way catalyst of what is called a straight-flow type and includes a honeycomb substrate (substrate) 10 and a catalyst layer 20 disposed on the honeycomb substrate 10. The honeycomb substrate 10 is a substrate that includes a cylindrically-shaped frame portion 11 and partition walls 14 dividing the space inside the frame portion 11 in a honeycomb shape. The frame portion 11 and the partition walls 14 are integrally formed. The partition walls 14 are porous bodies that define a plurality of cells 12 extending from an inflow side end surface 10Sa to an outflow side end surface 10Sb of the honeycomb substrate 10. The partition walls 14 have a shape including a plurality of wall portions 14L disposed to be separated from and parallel to one another, and a plurality of wall portions 14S disposed to be orthogonal to the plurality of wall portions 14L, separated from, and parallel to one another. The plurality of wall portions 14L and the plurality of wall portions 14S are arranged such that the plurality of cells 12 have square-shaped cross-sectional surfaces perpendicular to an extending direction. The partition walls 14 make a grid pattern in a cross-sectional surface perpendicular to the extending direction. The plurality of cells 12 are adjacent to one another across the partition walls 14, and inflow side ends 12a and outflow side ends 12b are open. The extending direction of the partition walls 14 is approximately the same as an axial direction of the honeycomb substrate 10, and the extending direction of the cell 12 is approximately the same as the extending direction of the partition walls 14.

As illustrated in FIG. 2, the catalyst layer 20 is disposed on a surface 14s on the cells 12 side (the cell-side surface 14s) of the partition walls 14 so as to occupy the entire honeycomb substrate 10 in the axial direction (extending direction of the partition walls 14). As illustrated in the enlarged view in FIG. 2, the catalyst layer 20 has a powder of the catalyst 6 according to the one embodiment. The powder of the catalyst 6 contains a powder of catalyst metal particles 2 according to the one embodiment and a powder of carrier particles (carrier) 4 on which the catalyst metal particles 2 are supported. The catalyst metal particles 2 are ternary alloy nanoparticles with a composition in terms of atomic ratio (a composition in atomic ratio) represented by the formula RhₓIr_{y}Pt_{z} (where x+y+z=100, 40≤x≤80, 10≤y≤40, and 10≤z≤40). In the catalyst metal particle 2, a surface layer 2b is Rh-rich compared with a central portion 2a.

Conventionally, catalyst metal particles containing Rh as the main component (hereinafter, referred to as “Rh-containing catalyst metal particles” in some cases), such as catalyst metal particles of Rh alone, realize excellent catalytic activity, for example, in reducing NOx by exhaust gas purification catalysts, compared to catalyst metal particles containing Pd, Pt, and the like as the main components. Accordingly, such characteristics are utilized. On the other hand, it is required to reduce the amount of Rh used in such conventional Rh-containing catalyst metal particles to suppress an increase in cost caused by a steep rise in the price of Rh. In contrast to this, in the catalyst metal particles 2 according to the one embodiment, Ir and Pt are contained in addition to Rh. The composition of the catalyst metal particles 2 is adjusted so that assuming that the total of the catalyst metal particles 2 (the sum of contents of Rh, Ir, and Pt) is 100 at % (atomic percent), the content of R^{h} is 40 at % or more and 80 at % or less, the content of Ir is 10 at % or more and 40 at % or less, and the content of Pt is 10 at % or more and 40 at % or less. These Rh, Ir, and Pt are alloyed. Accordingly, in the catalyst metal particles 2 according to the one embodiment, by changing the electron state of Rh to a different state, catalytic activity can be improved, for example, in reducing NOx by exhaust gas purification catalysts, compared to conventional Rh-containing catalyst metal particles. Furthermore, since the surface layer 2b is Rh-rich compared with the central portion 2a, the catalytic activity can be improved more effectively.

Therefore, with the catalyst metal particles 2 according to the one embodiment, the catalytic activity can be improved, for example, in reducing NOx by exhaust gas purification catalysts, compared to conventional Rh-containing catalyst metal particles. Furthermore, even though Ir and Pt are each contained in a range of 10 at % or more and 40 at % or less in addition to Rh, the catalytic activity can be improved. Therefore, the amount of Rh used can be reduced. The catalyst 6 according to the one embodiment can provide a similar effect by containing the catalyst metal particles 2. As a result, in the exhaust gas purification device 1 employing the catalyst 6, purification performance can be improved, and the amount of Rh used can be reduced. Subsequently, the details of the compositions of the catalyst metal particle and the catalyst according to the embodiments will be described.

### 1. Catalyst Metal Particle

The catalyst metal particle according to the embodiments is a ternary alloy particle the composition in terms of atomic ratio (the composition in atomic ratio) of which is a composition in terms of atomic ratio represented by the formula RhₓIr_{y}Pt_{z} (where x+y+z=100, 40≤x≤80, 10≤y≤40, and 10≤z≤40).

The contents of Rh, Ir, and Pt in the catalyst metal particle are described. The content of Rh is not particularly limited as long as it is 40 at % (atomic percent) or more and 80 at % or less, assuming that the sum of the contents of Rh, Ir, and Pt is 100 at %. In some embodiments, the content of Rh is 45 at % or more and 75 at % or less. Among others, it may be 50 at % or more and 70 at % or less, and in particular, it may be 55 at % or more and 65 at % or less. This is because when the content of Rh is equal to or more than the lower limits of these ranges, the improvement of the catalytic activity is facilitated. Also, when the content of Rh is equal to or less than the upper limits of these ranges, the amount of Rh used can be particularly reduced.

The content of Ir is not particularly limited as long as it is 10 at % or more and 40 at % or less, assuming that the sum of the contents of Rh, Ir, and Pt is 100 at %. In some embodiments, the content of Ir is 15 at % or more and 35 at % or less. Among others, it may be 20 at % or more and 30 at % or less, and in particular, it may be 22.5 at % or more and 27.5 at % or less. This is because when the content of Ir is equal to or more than the lower limits of these ranges, the reduction in the amount of Rh used is facilitated. Also, when the content of Ir is equal to or less than the upper limits of these ranges, the improvement of the catalytic activity is facilitated. The content of Pt is not particularly limited as long as it is 10 at % or more and 40 at % or less, assuming that the sum of the contents of Rh, Ir, and Pt is 100 at %. In some embodiments, the content of Pt is 15 at % or more and 35 at % or less. Among others, it may be 20 at % or more and 30 at % or less, and in particular, it may be 22.5 at % or more and 27.5 at % or less. This is because when the content of Pt is equal to or more than the lower limits of these ranges, the reduction in the amount of Rh used is facilitated. Also, when the content of Pt is equal to or less than the upper limits of these ranges, the improvement of the catalytic activity is facilitated.

The catalyst metal particle is not particularly limited as long as it is a particle as described above. However, it usually exists as a powder of catalyst metal particles. For example, in some embodiments, the catalyst metal particle is Rh-rich in the surface layer relative to the central portion (the atomic ratio of Rh content to the sum of Rh, Ir, and Pt contents is higher in the surface layer than in the central portion). This is because the catalytic activity can be improved more effectively.

The average particle size of the catalyst metal particles is not particularly limited, and for example, it is 1 nm or more and 120 nm or less. In some embodiments, the average particle size is 1 nm or more and 30 nm or less. Among others, it may be 1 nm or more and 10 nm or less, and in particular, it may be 1 nm or more and 5 nm or less. Here, the “average particle size of the catalyst metal particles” refers to the average value of particle sizes obtained by, for example, a method of observing the powder of catalyst metal particles contained in the powder of a catalyst described later by a transmission electron microscope (TEM), such as a scanning transmission electron microscope (STEM). For example, it is the calculated average value of circle equivalent diameters of 30 or more catalyst metal particles with a circle equivalent diameter of 1 nm or more, which are randomly selected in a TEM image.

While a method for producing the catalyst metal particle is not particularly limited, examples include, for example, a production method using the polyol reduction method. The polyol reduction method is a method in which metal ions are reduced by the reduction action of polyhydric alcohol (polyol) to precipitate nanosized metal particles. In the production method of catalyst metal particle using the polyol reduction method, for example, metal salts of Rh, Ir, and Pt are dissolved in polyhydric alcohol (a reducing agent), such as ethylene glycol, glycerin, diethylene glycol, and triethylene glycol, and they are heated at a predetermined temperature (such as 120° C.) for a predetermined time (such as 24 hours) to cause the metal salts to react and are allowed to cool, thereby obtaining a reaction solution containing a powder of catalyst metal particles containing Rh, Ir, and Pt in a solid solution state. Afterward, by separating the powder of catalyst metal particles from the reaction solution through centrifugal separation and the like, the catalyst metal particle is produced as a powder of catalyst metal particles. In this production method, the aggregation of the catalyst metal particles can be suppressed by adding, for example, a protective agent, such as polyvinylpyrrolidone and polyethylene glycol, to the polyhydric alcohol together with the metal salts. Furthermore, the average particle size of the catalyst metal particles can be controlled by adding, for example, a particle size regulator, such as sodium hydroxide and nitric acid, to the polyhydric alcohol together with the metal salts.

While the metal salt of Rh is not particularly limited as long as catalyst metal particles can be produced, examples include rhodium chloride (RhCl₃), rhodium acetate, and rhodium nitrate. While the metal salt of Ir is not particularly limited as long as catalyst metal particles can be produced, examples include iridium chloride (IrCl₃), iridium acetylacetonate, potassium iridium cyanate, and potassium iridate. While the metal salt of Pt is not particularly limited as long as catalyst metal particles can be produced, examples include chloroplatinic acid (H₂PtCl₆), chloroplatinic acid (H₂PtCl₄), potassium tetrachloroplatinate (II) (K₂PtCl₄), ammonium hexachloroplatinate (IV) ((NH₄)₂PtCl₆), and sodium hexachloroplatinate (IV) (Na₂PtCl₆).

### 2. Catalyst

The catalyst according to the embodiments contains the catalyst metal particle according to the embodiments and a carrier on which the catalyst metal particle described above is supported.

While the carrier is not particularly limited as long as catalyst metal particles can be supported, it usually exists as a powder of carrier particles (carrier). The average particle size of the carrier particles is not particularly limited, and for example, it is 1 nm or more and 500 nm or less. Here, the “average particle size of the carrier particles” refers to the average value of particle sizes obtained by a method of observing the powder of carrier particles by a TEM, such as STEM. For example, it is the calculated average value of circle equivalent diameters of 30 or more carrier particles with a circle equivalent diameter of 1 nm or more, which are randomly selected in a TEM image.

While the material of the carrier is not particularly limited as long as the material allows supporting the catalyst metal particle described above, it is, for example, an inorganic compound and the like. Specific examples include, for example, aluminum oxide (Al₂O₃), zirconia (ZrO₂), ceria (CeO₂), silica (SiO₂), titania (TiO₂), solid solutions thereof (such as a ceria-zirconia complex oxide), and combinations thereof in some embodiments. Among others, the material of the carrier may be aluminum oxide, zirconia, and the like. This is because the specific surface area is large, and the heat resistance is high.

While the catalyst is not particularly limited as long as it is the one as described above, it usually exists as a powder of catalyst containing a powder of catalyst metal particles and a powder of carrier particles (carrier) on which the catalyst metal particles are supported. In some embodiments, the catalyst is, for example, an exhaust gas purification catalyst used to purify an exhaust gas. This is because the exhaust gas purification catalyst can realize excellent catalytic activity and a reduction in the amount of Rh used.

The use of the exhaust gas purification catalyst is not particularly limited. However, in some embodiments, it is used in, for example, an exhaust gas purification device that includes, for example, a substrate and a catalyst layer disposed on the substrate, in which the catalyst layer contains the exhaust gas purification catalyst, such as the exhaust gas purification device employing the catalyst according to the one embodiment. The exhaust gas purification device may be a straight-flow type or a wall-flow type. It is a straight-flow type in some embodiments, and among others, it may be a three-way catalyst. Examples of the wall-flow type include, for example, a gasoline particulate filter (GPF) and a diesel particulate filter (DPF).

While a method for producing the catalyst is not particularly limited, examples include, for example, a method of preparing a catalyst slurry by immersing a powder of carrier particles in a reaction solution containing a powder of catalyst metal particles, which is obtained by a method for producing the catalyst metal particles using the polyol reduction method, and after that, for example, drying and baking the catalyst slurry.

### EXAMPLES

The following further specifically describes the catalyst metal particle and the catalyst according to the embodiments with examples and comparative examples.

1. Production of Powder of Catalyst Metal Particles, Powder of Catalyst, and Catalyst Pellets

### Example 1

A powder of catalyst metal particles with a composition in terms of atomic ratio represented by the formula Rh₈₀Ir₁₀Pt₁₀ and a powder of a catalyst (exhaust gas purification catalyst) containing the powder of the catalyst metal particles were produced. Then, the powder of the catalyst was pelletized to produce catalyst pellets.

First, the polyol reduction method was used to produce the powder of the catalyst metal particles. Specifically, first, in ethylene glycol as a reducing agent, rhodium chloride (RhCl₃), iridium chloride (IrCl₃), and chloroplatinic acid (H₂PtCl₆) as metal salts were dissolved such that the atomic ratio of Rh, Ir, and Pt was the atomic ratio (80:10:10) of the above formula, and polyvinylpyrrolidone as a protective agent was further dissolved. Then, they were heated at 120° C. for 24 hours. Accordingly, the powder of the catalyst metal particles was produced, and a reaction solution containing the powder of the catalyst metal particles was obtained. At this time, a particle size regulator was added to the ethylene glycol together with these metal salts. Subsequently, a catalyst slurry was prepared by immersing a powder of carrier particles constituted of aluminum oxide in the resulting reaction solution. Next, the catalyst slurry was coated on a substrate, dried, and baked to produce a powder of a catalyst containing the powder of the catalyst metal particles and the powder of the carrier particles on which the catalyst metal particles were supported. In this case, the amount of the catalyst metal particle powder and the amount of the carrier particle powder during the preparation of the catalyst slurry were adjusted so that the support amount of the catalyst metal particles per 1 g of the powder of the carrier particles was 20 μmol/g. Subsequently, catalyst pellets were produced by pelletizing the resulting catalyst powder.

### Examples 2 to 12 and Comparative Examples 1 to 3

A powder of catalyst metal particles with a composition in terms of atomic ratio represented by each formula shown in Table 1 below and a powder of a catalyst (exhaust gas purification catalyst) containing the powder of the catalyst metal particles were produced. Then, the powder of the catalyst was pelletized to produce catalyst pellets. In this case, the powder of the catalyst metal particles and the powder of the catalyst were produced, and the catalyst pellets were produced, similarly to Example 1, except that rhodium chloride, iridium chloride, and chloroplatinic acid were dissolved in ethylene glycol such that the atomic ratio of Rh, Ir, and Pt was the atomic ratio of each formula representing the composition shown in Table 1 below when the powder of the catalyst metal particles was produced.

### Comparative Example 4

A powder of catalyst metal particles of Rh alone and a powder of a catalyst (exhaust gas purification catalyst) containing the powder of the catalyst metal particles were produced. Then, the powder of the catalyst was pelletized to produce catalyst pellets. In this case, the powder of the catalyst metal particles and the powder of the catalyst were produced, and the catalyst pellets were produced, similarly to Example 1, except that only rhodium chloride was dissolved as a metal salt in ethylene glycol when the powder of the catalyst metal particles was produced.

### Comparative Example 5

A powder of catalyst metal particles of Ir alone and a powder of a catalyst (exhaust gas purification catalyst) containing the powder of the catalyst metal particles were produced. Then, the powder of the catalyst was pelletized to produce catalyst pellets. In this case, the powder of the catalyst metal particles and the powder of the catalyst were produced, and the catalyst pellets were produced, similarly to Example 1, except that only iridium chloride was dissolved as a metal salt in ethylene glycol when the powder of the catalyst metal particles was produced.

### Comparative Example 6

A powder of catalyst metal particles of Pt alone and a powder of a catalyst (exhaust gas purification catalyst) containing the powder of the catalyst metal particles were produced. Then, the powder of the catalyst was pelletized to produce catalyst pellets. In this case, the powder of the catalyst metal particles and the powder of the catalyst were produced, and the catalyst pellets were produced, similarly to Example 1, except that only chloroplatinic acid was dissolved as a metal salt in ethylene glycol when the powder of the catalyst metal particles was produced.

### 2. Evaluation

### [STEM Observation and EDX Composition Analysis]

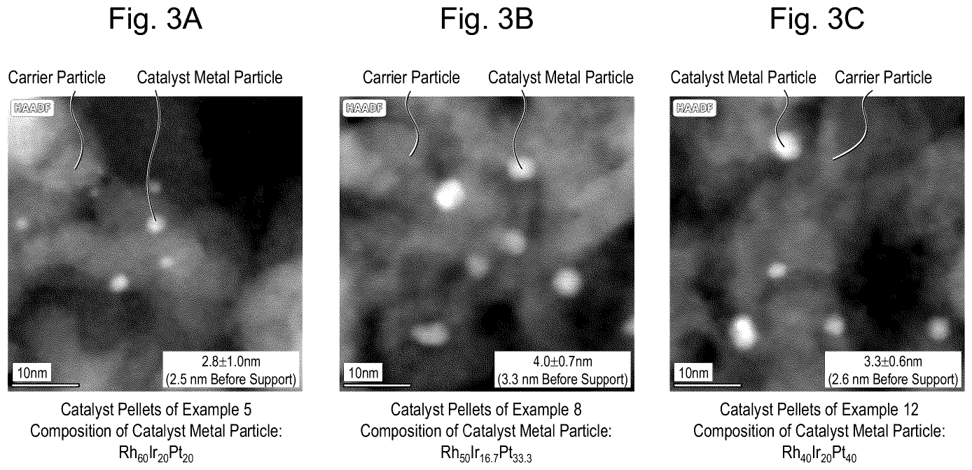

The average particle size of the powder of the catalyst metal particles in the reaction solution containing the powder of the catalyst metal particles obtained at the time of the production of the powder of the catalyst metal particles in Examples 1 to 12 and Comparative Examples 1 to 4 was measured by sampling the reaction solution and observing it by TEM. At this time, 30 or more catalyst metal particles with a circle equivalent diameter of 1 nm or more were randomly selected in the TEM image, and the calculated average value of their circle equivalent diameters was obtained as the average particle size of the powder of the catalyst metal particles. The result is shown in Table 1 below. In addition, samples taken from the catalyst pellets produced in Examples 5, 8, and 12 were observed by STEM. FIGS. 3A to 3C are STEM images of the catalyst pellets of Examples 5, 8, and 12, respectively. The particle size of the catalyst metal particles in the catalyst pellets of Example 5 illustrated in FIG. 3A is in the range of 2.8±1.0 nm. The particle size of the catalyst metal particles in the catalyst pellets of Example 8 illustrated in FIG. 3B is in the range of 4.0±0.7 nm. The particle size of the catalyst metal particles in the catalyst pellets of Example 12 illustrated in FIG. 3C is in the range of 3.3±0.6 nm. The particle sizes of the catalyst metal particles in the catalyst pellets of Examples 5, 8, and 12 illustrated in these STEM images are nearly unchanged from the average particle sizes of the powders of the catalyst metal particles in the reaction solutions of Examples 5, 8, and 12 shown in Table 1 below.

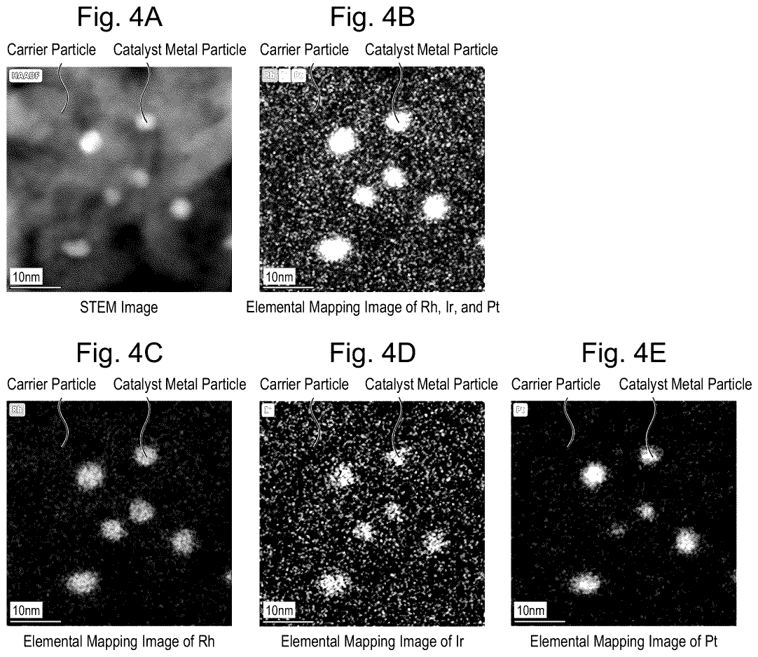

Furthermore, along with the observation by STEM, elemental mapping by energy dispersive X-ray analysis (EDX) was performed on the sample taken from the catalyst pellets produced in Example 8. FIGS. 4A to 4E are a STEM image of catalyst pellets, an elemental mapping image of Rh, Ir, and Pt, an elemental mapping image of Rh, an elemental mapping image of Ir, and an elemental mapping image of Pt in Example 8, respectively. From the elemental mapping images illustrated in FIGS. 4B to 4E, it can be confirmed that Rh, Ir, and Pt are alloyed in the catalyst metal particles in the catalyst pellets of Example 8. Furthermore, it can be seen that the catalyst metal particle is Rh-rich in the surface layer relative to the central portion (the atomic ratio of Rh content to the sum of Rh, Ir, and Pt contents is higher in the surface layer than in the central portion).

### [Catalytic Activity Evaluation]

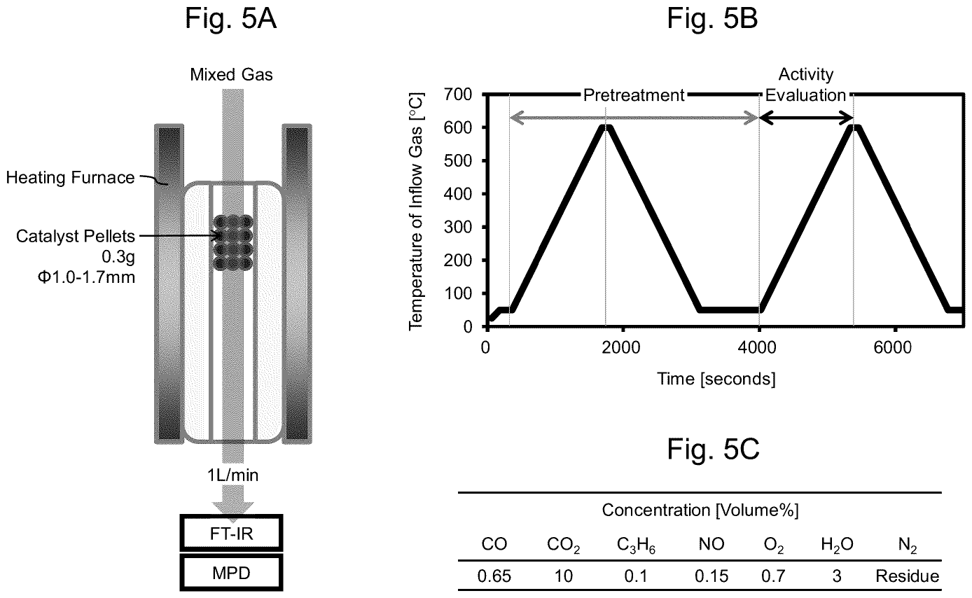

The catalytic activity of the catalyst pellets in each of Examples 1 to 12 and Comparative Examples 1 to 6 was evaluated using a fixed-bed type flow reactor illustrated in FIG. 5A and using a temperature program (temperature conditions for pretreatment and activity evaluation) illustrated in FIG. 5B and a mixed gas with a composition illustrated in FIG. 5C.

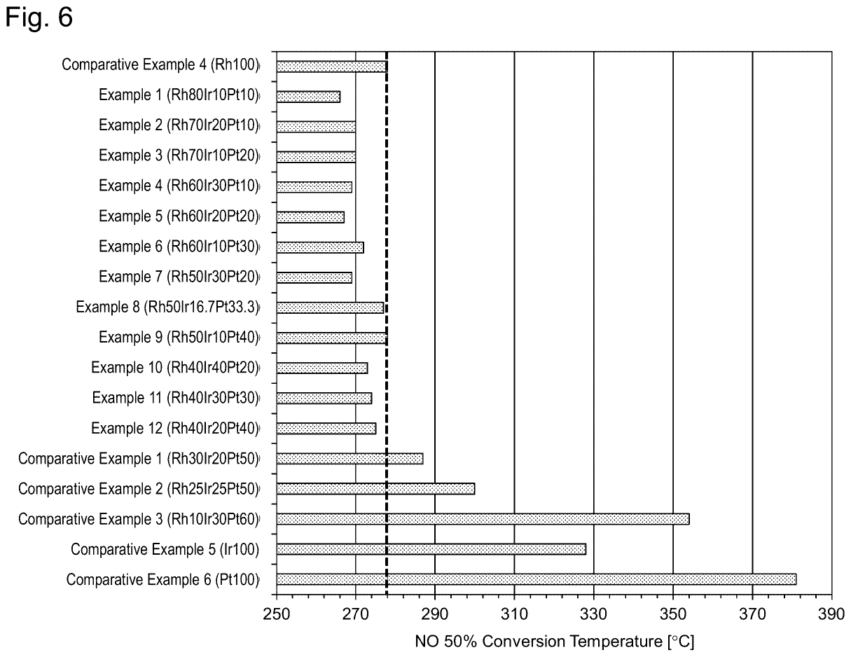

In this case, first, a sample of 0.3g taken from the catalyst pellets was loaded into a heating furnace of the fixed-bed type flow reactor. Next, the pretreatment was performed by increasing the temperature of a mixed gas flowing into the sample (hereinafter, abbreviated as “inflow gas” in some cases) by the heater of the heating furnace from normal temperature to 600° C. in about 1400 seconds, then lowering the temperature to normal temperature in about 1400 seconds, and maintaining it at normal temperature for about 900 seconds according to the temperature condition for the pretreatment illustrated in FIG. 5B, while flowing the mixed gas in the heating furnace at a flow rate of 1 L/min. Next, the activity evaluation was performed by measuring the concentration [volume %] of each component of a gas flowing out of the sample (hereinafter, abbreviated as “outflow gas” in some cases) by a FT-IR (Fourier transform infrared spectroscopy) analyzer and a Magnetic Pressure type (MPD) analyzer of the fixed-bed type flow reactor in the process of increasing the temperature of the inflow gas by the heater of the heating furnace from normal temperature to 600° C. in about 1400 seconds according to the temperature condition for the activity evaluation illustrated in FIG. 5B while continuously flowing the mixed gas in the heating furnace at a flow rate of 1 L/min. In the activity evaluation, in particular, the temperature at which 50% of NO in the inflow gas was converted to N₂ was determined as a NO 50% conversion temperature [° C.]. The result is shown in Table 1 below. FIG. 6 is a graph illustrating the NO 50% conversion temperature of each sample of Examples 1 to 12 and Comparative Examples 1 to 6.

TABLE 1

| | Formula RhxIryPtz | Average Particle | |
|---|---|---|---|
| | (*) Representing | Size of Powder | NO 50% |
| | Composition in | of Catalyst | Conversion |
| | Terms of Atomic Ratio | Metal Particles | Temperature |
| | (x + y + z = 100) | [nm] | [° C.] |
| Comparative | Rh₁₀₀ | 2.6 | 278 |
| Example 4 | | | |
| Example 1 | Rh₈₀Ir₁₀Pt₁₀ | 2.3 | 266 |
| Example 2 | Rh₇₀Ir₂₀Pt₁₀ | 2.3 | 270 |
| Example 3 | Rh₇₀Ir₁₀Pt₂₀ | 2.4 | 270 |
| Example 4 | Rh₆₀Ir₃₀Pt₁₀ | 2.3 | 269 |
| Example 5 | Rh₆₀Ir₂₀Pt₂₀ | 2.5 | 267 |
| Example 6 | Rh₆₀Ir₁₀Pt₃₀ | 2.4 | 272 |
| Example 7 | Rh₅₀Ir₃₀Pt₂₀ | 2.3 | 269 |
| Example 8 | Rh₅₀Ir_{16.7}Pt_{33.3} | 3.3 | 277 |
| Example 9 | Rh₅₀Ir₁₀Pt₄₀ | 2.9 | 278 |
| Example 10 | Rh₄₀Ir₄₀Pt₂₀ | 2.5 | 273 |
| Example 11 | Rh₄₀Ir₃₀Pt₃₀ | 2.5 | 274 |
| Example 12 | Rh₄₀Ir₂₀Pt₄₀ | 2.6 | 275 |
| Comparative | Rh₃₀Ir₂₀Pt₅₀ | 3.0 | 287 |
| Example 1 | | | |
| Comparative | Rh₂₅Ir₂₅Pt₅₀ | 2.8 | 300 |
| Example 2 | | | |
| Comparative | Rh₁₀Ir₃₀Pt₆₀ | 2.7 | 354 |
| Example 3 | | | |
| Comparative | Ir₁₀₀ | — | 328 |
| Example 5 | | | |
| Comparative | Pt₁₀₀ | — | 381 |
| Example 6 | | | |

As shown in Table 1 above and FIG. 6, it can be seen that in the catalyst pellets of Examples 1 to 12 containing the catalyst metal particles with a composition in terms of atomic ratio represented by the formula RhₓIr_{y}Pt_{z} (where x+y+z=100, 40≤x≤80, 10≤y≤40, and 10≤z≤40), the NO 50% conversion temperature decreases, and the catalytic activity improves, compared to the catalyst pellets containing the catalyst metal particles of Rh alone in Comparative Example 1. It is considered that Rh, Ir, and Pt were alloyed in the catalyst metal particles to change the electron state of Rh to a different state, thereby developing the low-temperature activity of the catalyst. Furthermore, it can be seen that even in the catalyst pellets of Examples 10 to 12 with a Rh content of 40 at % (atomic percent), the catalytic activity improves despite the low Rh content. The result is thought to be due to the fact that the catalyst metal particles of Examples 10 to 12 are also Rh-rich in the surface layer relative to the central portion, similarly to the result shown in the elemental mapping image by EDX as described above.

While the embodiments of the catalyst metal particle and the catalyst according to the present disclosure have been described in detail above, the present disclosure is not limited thereto, and can be subjected to various kinds of changes in design without departing from the spirit and scope of the present disclosure described in the claims.

All publications, patents and patent applications cited in the present description are herein incorporated by reference as they are.

### DESCRIPTION OF SYMBOLS

1 Exhaust gas purification device
2 Catalyst metal particle
4 Carrier particle (carrier)
6 Catalyst (exhaust gas purification catalyst)
10 Honeycomb substrate (substrate)
20 Catalyst layer

What is claimed is:

1. A catalyst metal particle comprising
a composition in terms of atomic ratio represented by the formula RhₓIr_{y}Pt_{z},
wherein x+y+z=100, 40≤x≤80, 10≤y≤40, and 10≤z≤40.

2. A catalyst comprising:
the catalyst metal particle according to claim 1; and
a carrier on which the catalyst metal particle is supported.

3. The catalyst according to claim 2, wherein
the catalyst is an exhaust gas purification catalyst.
